(19) United States
(12) Patent Application Publication
(10) Pub. No.: US 2007/0007359 A1
(43) Pub. Date: Jan. 11, 2007

(54) System and method for generating variably configured magnetic templates

(75) Inventor: Roger E. Kraft, Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/177,723

(22) Filed: Jul. 8, 2005

(51) Int. Cl. G06K 19/06

(52) U.S. Cl. 235/493

(57) ABSTRACT

The present invention discloses a method and system for preparing variably configured business communication magnetic templates that may be used in connection with marketing, advertising, promotional and information conveying activities. The method includes the preparation of a magnetic assembly having a top printable surface that is bonded to a magnetic layer. The template intermediates are printed on the printable surface of the substrate and are then cut through the use of electromagnetic energy appearing in one of visible, infrared and ultraviolet light spectrums. In a continuing embodiment, once the templates are printed and cut from the substrate, the templates may then be mounted on the surface of a carrier web for further processing and packaging for delivery to an end user customer.

### CROSS-REFERENCES TO RELATED APPLICATIONS

None.

### FIELD OF THE INVENTION

The present invention is found in the field of processes that are used in the manufacture of printed or imaged business communication materials. More specifically, the present invention is directed toward a method and system for creating variably configured magnetic templates that are used in the preparation of marketing, advertising and business communication media. The system of the present invention utilizes one or more digitally rendered templates in connection with a system that generates electromagnetic radiation in one of the ultraviolet, visible or infrared regions of the light spectrum to produce printed communication products from a previously printed or imaged continuous web or sheet of material that has a layer of ferromagnetic material bonded to a printable media.

### BACKGROUND OF THE INVENTION

There are wide varieties of product offerings available in the market today that serve multiple purposes and functions, including product offerings that are used in fulfilling the needs of particular market segments and other business communication constructions that are used to convey or handle information.

Printed products, such as pieces that are intended to be used in business, advertising and marketing communications, can be delivered in a wide variety of formats, constructions and configurations. Normally, one of the most significant limiting factors for a manufacturer being able to produce a particular construction or expand product capabilities is the equipment that the manufacturer has on hand to generate such printed pieces or alternatively, the cost and expense that is associated with delivering such products.

Traditional manufacturers of business communications, such as business forms and labels, are also usually limited in the type of jobs that a manufacturer will accept based on size of the job, or more particularly the order quantity or value of the order. That is, due to cost factors, a customer will not place an order with a manufacturer for a small to medium sized piece quantity as the set up or make ready of the job makes the order cost prohibitive, even assuming that the manufacturer would accept the order if a particular price could be obtained to justify production.

The foregoing difficulty is largely based on conventional manufacturing techniques that normally utilize webs of material that are successively printed or otherwise treated in order to produce a finished product assembly. As such, small to medium sized runs of product are generally not adaptable to this type of manufacture due to the amount of material (length of a web) that must be used in order to prepare a particular job and manufacture the product in a cost effective manner.

These manufacturing limitations thus curtail the type of communication product that a marketing or advertising agency may be able to obtain for a client in connection with a specific promotion or offering. This in turn may impact the amount of creativity that such an agency may utilize in effectively marketing the client's products or services. For example, many promotional pieces that utilize magnetic materials typically are limited in configuration to a number of shapes, such as quadrate, that a manufacturer of such pieces may be able to provide to a customer or end user.

Another difficulty often encountered in attempting to interject creativity into the design of advertising, promotional and business communication pieces is that the manufacturer must purchase numerous dies and other configurations in order to cut the desired shapes and designs from the web or sheet of material. Such dies are generally produced from a metal cylinder or plate into which the particular design is cut. Over time, the design in the die will wear down due to use and will need to be replaced.

Such a system of holding and procuring dies, requires a manufacturer to maintain a relatively large inventory of dies in order to accommodate various orders and the designs associated with producing those manufacturing jobs. In addition to the space required to house the inventory, the manufacturer must also have equipment on hand to be able to accommodate the insertion and removal of the dies from the manufacturing equipment. The movement of dies into and out of the equipment can lead to other unfortunate events such as damage to the dies and equipment and perhaps even injury to the personnel.

In addition, with each new design a new die must be purchased, which can be expensive. Most manufacturers will either attempt to pass the cost of the die onto the customer or will amortize the cost of the die over a period of time, provided that the value of the potential order is sufficiently large to justify the capital expenditures that are needed in connection with the acquisition of the die. When the cost is passed along to the customer, the added cost of a die can discourage many potential customers from moving ahead with an order.

Magnetic materials have become increasingly common in the business forms and labels industry. Today's growth of new technology plays a vital role in creating innovative communication pieces, which can be used in a variety of businesses and industries.

Magnets have been previously attached to materials and used for purposes of marketing and advertising. Some exemplary prior uses of magnets include calendars, business cards, frames for photographs, advertising collateral and the like. One example of such a prior art construction is provided in U.S. Pat. No. 5,458,282. The construction includes a solid magnet that is attached to one end of a substrate and, placed between end edges of the substrate and before the separation line of the adjoining substrate section. The difficulty associated with such prior art constructions is that this construction is often limited in usage to the one advertising arrangement provided with the assembly. That is, the magnet may contain a single business card or reference or contact number and the adjoining substrate may only include printed indicia related to that one event.

Such single purpose forms may require a minimum purchase of several hundred or even several thousand products. This requirement is generally not economical for a small business, which may only need to purchase a few dozen personalized products for selected customers.

In addition, to the foregoing drawback, such a construction also requires a magnetic piece to be physically affixed to a substrate in order to use the product for its intended purpose, that of enabling the substrate to be applied to a metallic surface. Due to the increased thickness of the magnetic material, the substrate with the magnet attached cannot easily pass through a laser or other non-impact printer in light of the hump or bump created by the magnet. This hump can distort the printing of the substrate and potentially cause excessive wear and tear to the print head of the printer due to the abrupt contact with the raised area of the magnet. Thus, the substrate must first be printed and then have the magnetic piece attached thereto. As might be expected, this can create alignment problems if the magnetic material is applied to the incorrect area of the substrate.

More importantly, however, the foregoing thus eliminates the ability for use of such products by small office/home office (“SOHO”) environments, as such environments would not have the desire to purchase rolls of magnetic material, cut the material to size and then affix the material to the substrate being printed. In addition, this prior art construction then virtually eliminates the ability to individually personalize such magnetic pieces, regardless of the size of the business.

What is needed therefore, is a method and system for creating business communication, advertising and marketing pieces having magnetic layers applied thereto that may be produced with variable information in one of a number of preconfigured formats and which does not suffer from the drawbacks enumerated above. In addition, there is a need for a magnetic communication piece that has an integral magnetic portion formed therewith that can be produced on an economical and efficient scale.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention is directed to the production of variably configured magnetic templates that can be used in fulfilling orders or production orders for business, marketing, advertising, promotional and other information handling needs of a particular end user. Preferably, the method of the present invention is utilized in connection with the preparation of products for resellers or distributors of such products rather than directly for end users themselves. It should however be understood that the method may of course be used for the preparation of product for end user customers with little if any adaptation.

The method of the present invention contemplates the use of an electromagnetic radiation generating device that produces energy in one of the visible, infrared or ultraviolet light spectrums. It has been found that through the use of such technology, a greater variety of patterns, designs and the like can be created without suffering from the drawbacks associated with conventional die cutting technology. Moreover, it has surprisingly been discovered that such technology has heretofore been unused in the preparation of magnetic template assemblies.

In a supplemental embodiment that may be used in connection with practicing the present invention, the magnetic templates, once severed from the substrate on which they are prepared, can be placed, in a sequential and regularly occurring manner, on a carrier web and then subsequently collected for use at a later time or to provide an alternate delivery system for use by a distributor or end user.

In one exemplary embodiment of the present invention, a method for producing variably configured business communication magnetic templates is presented and includes the steps of initially obtaining an order for a magnetic business communication piece. Then, designing a layout for the business communication piece is conducted with the layout including at least a printed portion and a piece shape configuration, that will outline the final shape the piece is to take after all of the steps of the current method have been performed.

Next, a substrate is prepared, with the substrate having a top printable surface and lower magnetic layer. The top printable surface is permanently bonded to the lower magnetic layer such as through the use of a permanent adhesive or other bond such as thermal treatment. Preparation of the substrate includes the feeding of a printable surface web to a web of magnetic material and then bonding the two webs together. Alternatively, the substrate can be procured from a supplier of such material.

Once the substrate is available, the substrate is transferred to a printing station that will be used to affix or image the printed information on the substrate on the top printable surface to produce a printed intermediate. The printed intermediate is then moved or transferred to a cutting station, where the intermediate is cut from the substrate in accordance with the piece shape configuration that was prepared during the layout step described above. The resulting step produces at least one variably configured business communication magnetic template.

In a further embodiment, a method for creating printed magnetic communication pieces for marketing and advertising clients is presented and includes the steps of initially soliciting production of magnetic communication product orders from one or more clients that have end users customers that utilize marketing and advertising materials.

At least one order is obtained or procured from one of the clients and the order includes at least the rendering of textual and graphical depictions on a substrate having a magnetic layer. A layout of the order is prepared digitally for use in preparing the substrate. The layout includes at least information relating to placement of the textual and graphical depictions of the substrate and shape configuration information that the individual pieces will take.

Next, a substrate is provided with the substrate having a top printable layer and a bottom magnetic layer. A portion of the top printable layer is permanently bonded to the magnetic layer.

Textual and graphical depictions are then imaged on the top printable layer of the substrate to create an intermediate substrate that has at least one area prepared in connection with the order. The intermediate substrate is then transferred to a separating station that will separate at least one area from the substrate. The printed area, representing the template for the order is then cut from the substrate by using electromagnetic radiation in a light spectrum selected from visible, infrared or ultraviolet to create a business communication magnetic product. The business communication magnetic product is then collected and packaged for delivery.

In a yet still further embodiment, a method of producing a series of magnetic business communication templates is presented and includes the steps of initially preparing a layout for an order for a series of magnetic business communication templates. The layout includes a printed design portion and a shape configuration determination.

Next, a substrate sized and configured is provided to receive the series of magnetic business communication templates. The substrate has a top printable surface that is bonded to a magnetic lower surface. Each of the templates is printed on the top printable surface of the substrate on the top printable surface. Then, each of the templates is cut from the substrate by using electromagnetic radiation in a light spectrum selected from visible, infrared or ultraviolet to create individual printed business communication magnetic products. Each of the printed business communication magnetic products is then placed sequentially on a carrier web then preparing the printed business communication magnetic products for delivery to a customer.

The products produced in accordance with the present invention can be used in various marketing, advertising, promotional and information handling campaigns and may be designed with a high degree of creativity as there is no longer a limitation created by the requirement to procure dies or other handling equipment so as to be able to render the shaped, individual pieces.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a block diagram illustrating one exemplary method of carrying out the present invention;

FIG. 2 presents a further block diagram that is used to depict an exemplary method in producing products in accordance with the present invention;

FIG. 3 shows a side view of a business communication assembly produced in accordance with the present invention;

FIG. 4 illustrates a top view of a magnetic business communication piece prepared in accordance with one of the exemplary methods disclosed herein; and

FIG. 5 depicts an alternative embodiment of the present invention in which a series of magnetic business communication pieces are disposed on a carrier web.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

It has been unexpectedly discovered that efficient and economical operations for the preparation of variably configured magnetic templates can be accomplished through the use of a cutting mechanism that utilized electromagnetic radiation in one of the visible, infrared or ultraviolet light spectrums. Through the use of such technology, a great amount of variably and creativity can be applied to the manufacture and preparation of such magnetic communication pieces.

As used herein the term “business communication piece or document” is used to refer to a substrate that either alone or in combination with other documents can convey a particular message, image or information about a particular product or service that is available from the provider of such pieces or documents. Business communication documents or pieces can include business forms, stationery, business cards, advertising, sales and marketing collateral and such other items used to convey information in a written or imaged form.

As used herein an “order” or a “production order” refers to an order for a single product type, selected for example from a group including labels, prime labels, cards, tags, magnetic products, laminated products, printed pieces and the like. Where two or more orders are produced in a single production run, the orders may come from a single entity or from multiple discrete entities, that is, one customer or multiple customers.

For example, a restaurant may order magnets for placement on “take-out” food containers and coupons or gift checks for in store promotions. Each item, the magnet and coupon, in this example, represents an order for a particular product, although each of the products originate from the same customer or end user and will be likely paid through a single invoice.

Likewise, two distinct end users or distributors may each place an order for a magnetic product, for each of their respective uses, and each magnetic product will have distinct indicia or graphics for the magnet application. Thus, there are two distinct orders, each for a magnetic product, two invoices and two customers. In each of these examples, the products or orders can be generated in the same production run as opposed to conventional processes, such as flexography, where the orders must be run separately from each other. Thus, by using the current process and system, a number of small to medium sized orders can be produced, which heretofore may not have been possible due to quantity restrictions.

The term “personalized information” refers to information that is printed or imaged onto a substrate or document which is generally variable or unique and which may change from document to document or segment to segment so as to create a customized message or communication for each recipient. Examples of personalized information may include names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturing or supplier wishes to convey to an end user or customer of the offering.

The term “intermediate” as used herein refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product such as with the present invention is provided in an intermediate condition so that a user can add or manipulate the intermediate to create the final or desired end product, such as applying the magnetic product to a container, carton or the like. Thus, in accordance with the present invention, the intermediate segment for example, could be subject to die cutting or additional printing, such as through ink jetting, over laminating, coating or embossment, and then applied to a container, carton, consumer package good or the like.

As used herein, the term “templates”, “segment”, “ribbon” or “element” refers to a particular size, configuration or arrangement of a piece. For example, if the template or segment includes a series of magnetic pieces, each piece may have a size of 2″×4″, 1″×2″ and other sizes that may be customarily produced. Likewise, if the piece is a larger magnetic card, the card may have a size ranging from 3″×5″, 2″×4″ or any other suitably sized card. The term templates can be used to refer to segments, ribbons and similar terms.

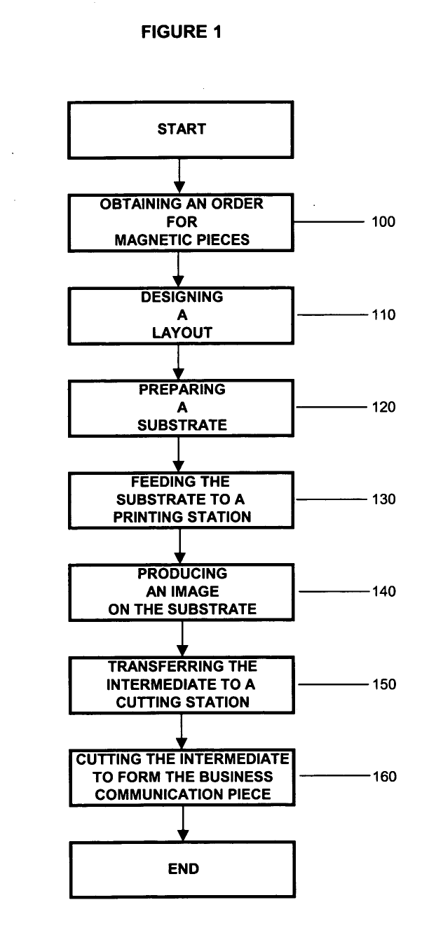

Turning now to FIG. 1 which depicts a block diagram setting forth an exemplary method suitable for carrying out the present invention. The process is started by obtaining an order for at least one type of magnetic business communication piece at step 100. The orders will preferably be generated in connection with advertising or solicitation activity that will occur by preparing printed advertisements in relevant trade associating magazines, fax and e-mail campaigns, and other oral or visual media that may be used in connection with promoting ones product. While the present invention is intended to be used in connection with selling products and services to resellers or distributors who then resell the product to an actual end user, it should be understood that the invention may be practiced so that the products are sold directly to an end user customer.

Next, once the order is received at step 100, a layout is prepared, preferably by creating one or more digital files on a computer at step 110. The layout will have at least two components, one component relating to the printing or imaging that will appear on the surface of the business communication piece and the other relating to the shape configuration that the piece will take after processing has been completed. The substrate is prepared at 120.

The printing or imaging that is applied to the surface of the substrate may be static or fixed indicia or alternatively, the imaging may include personalized indicia that vary from piece to piece.

Next, the substrate is fed to a printing station at step 130. While in the exemplary embodiment, printing is applied only to one surface of the substrate, it should be understood that printing may be applied to both surfaces of the substrate if needed. Examples of image generating or high quality printing devices that are suitable for use in practicing the invention include high resolution imaging devices such as Indigo®, available from Hewlett Packard of Palo Alto, Calif. or Karat available from KBA of Williston, Vt. Ideally, the present invention seeks to provide a segment or intermediate with a series of segments that has a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

The imaging equipment then renders an image in an area of the substrate which will become the final piece that is to be delivered to the end user customer. The printing may include textual information, graphical depictions or both at step 140. Once the intermediate is printed, it is passed to a cutting station at step 150, where cutting of the substrate separates the printed area from the unprinted area or matrix portion of the substrate at step 160.

An example of a device used for generating electromagnetic radiation in one of the infrared, visible and ultraviolet light spectrums is available from AB Graphic International, Ltd. of Bridlington, East Yorkshire, England and sold under the trade name SABRE.

The system used in practicing the present invention will generally be able to hold a number of discrete jobs or orders so that multiple magnetic business communication pieces may be prepared in a sequential fashion. That is, after the preparation of one order is completed the method may then be practiced almost immediately on the next order in the sequence to be produced.

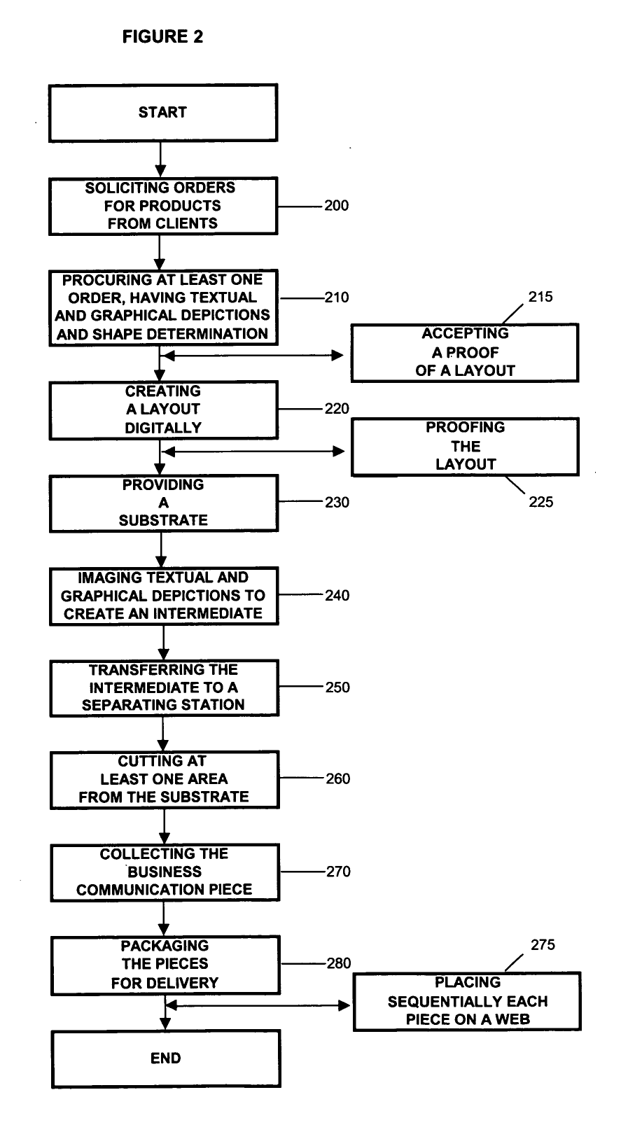

Turning now to FIG. 2 which provides another block diagram illustrating an exemplary method of practicing the present invention. The process is again begun by the solicitation of orders for magnetic products at step 200. As mentioned previously, the clients to whom solicitations are made will generally be those that have end user customers that are in need of advertising, marketing, promotional and other business information handling needs.

At least one order is procured at step 210. The order may be generated by sending in an order acknowledged, quote confirmation or other document either by mail, facsimile or electronically. The order may be accompanied by a pre-proof of a proposed layout which may be accepted at step 215 by the client or end user customer. Once, when at least one order has been received at step 210, a layout is created, preferably in a digital format at step 220. The layout will preferably include at least two components, a printed component and a shape component. The layout may be subjected to proofing, error correction and other “pre-flight” steps, step 225, prior to the layout being readied for production in accordance with the presently described method.

Next, a substrate is provided at step 230. The substrate will have at least one printable surface, although it should be understood that printing may be applied on more than one surface. The substrate will also have a magnetic layer to which the top printable layer is preferably permanently bonded, such as by use of a permanent adhesive.

Imaging is then applied to the printable surface or surfaces of the substrate at step 240. As described above, preferably a high quality image will be used in connection with printing the substrate of the present invention. After the image has been printed to create an intermediate assembly, the intermediate is transferred to a separating station at step 250. The separating station will apply electromagnetic radiation at step 260 to cut the printed or imaged area from the surrounding portion of the substrate to create at least one magnetic business communication piece at step 270.

Preferably, in preparing the magnetic business communication piece of the present invention, an order for such products will typically include a number of pieces and discrete areas will be created in the digital layout and then subsequently on the surface of the substrate. The areas of the layout will then be rendered so as to create a number of individual piece intermediates which will then be cut from the substrate to create a number or series of individual magnetic communication pieces.

After the pieces are created, the pieces may be packaged for delivery at step 280 or alternatively and prior to packaging, the pieces may be placed sequentially on a carrier web at step 275 as will be subsequently described herein.

The production of an alternate embodiment including the magnetic business communication pieces that are prepared in accordance with the present invention includes an intermediate web assembly that has intermittent laminations. That is, portions of the magnetic communications are adhered to the web and smaller portions, such as the edges, may be free of adherence due to a slight overlap between successive magnetic communications disposed on the web. The overlap is preferably less than an inch, more preferably less than one half of one inch and still more preferably less than about 1/32″ and still yet more preferably less than about 1/64″. The overlap may be created to facilitate the placing of magnetic communications on the web and accommodates slight changes in timing that may occur due to web or placer mechanism speed. It should be understood that it may not be necessary to create an overlap and the magnetic communications may be laid edge to edge or alternatively the magnetic communications may be spaced from one another along the web. In this latter configuration, the adhesive, if exposed may be deadened by application of radiation, over coatings or the like.

An exemplary device suitable for placing the individual magnetic business communication pieces on the web includes a Maverick®available from InLine Automation of Minneapolis, Minn. The unit includes a hopper that holds a series of individual pieces. Each piece is then fed in a sequential manner, such as through the use of a rotating cylinder to a moving web where the piece is deposited.

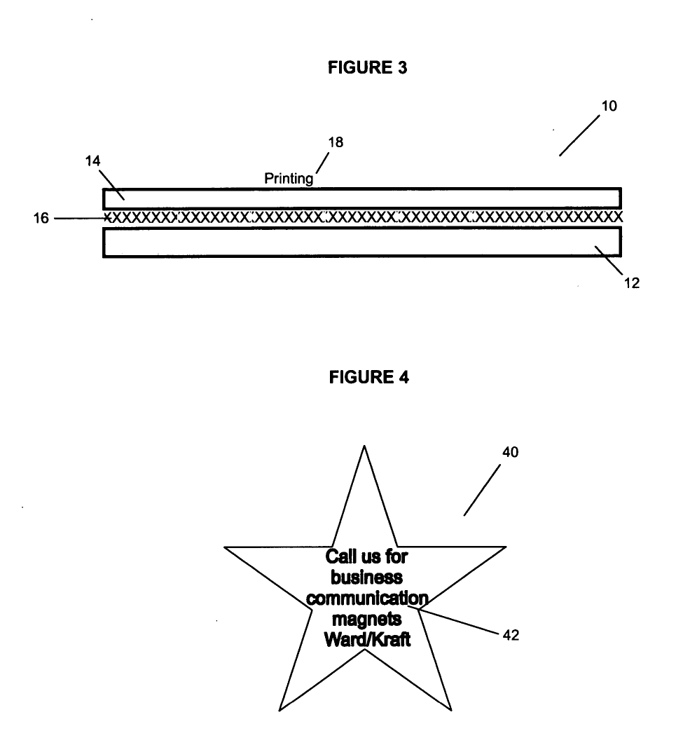

Turning now to FIG. 3 of the presently described invention, a side, cut away view of a magnetic business communication piece is presented and referenced generally by numeral 10. The piece 10 has a magnetic layer 12 and a top printable surface 14 which is permanently bonded to the magnetic layer 12 by a permanent adhesive 16. The top printable layer 14 is shown with printing 18 applied to the surface. The printing can be applied using ink jet, toner or other suitable mediums for creating representative textual and graphical depictions on the surface of the assembly.

The substrate will generally have first and second longitudinally extending sides and first and second transversely extending edges and first and second surfaces and faces. The substrate may be provided in a cut sheet format or alternatively, the substrate may be presented initially in a continuous Web format which may then be sheeted or cut into individual sheets. Selection of the substrate should be such that it is adequately sized and configured to hold one or more magnetic business communication pieces between the edges and sides.

Reference is now directed to FIG. 4 of the presently described invention. In this drawing FIG. 4, a shaped magnetic business communication piece is generally referenced by numeral 40. The shape of the piece, here shown a geometric configuration of a star, will have been chosen by the client when placing an order or alternatively, could have been designed by in-house graphics personnel that may have recommended the shape to the potential end user customer. It should be understood that other shapes are possible including animate, inanimate, alpha and numeric, etc. The shaped piece 40 is shown with imaging 42 which may be static, fixed or personalized information.

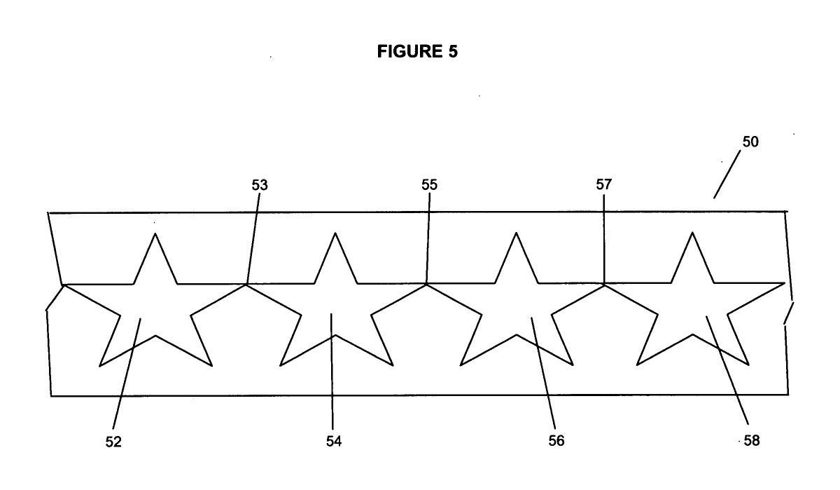

FIG. 5 of the presently described invention shows an alternative delivery configuration of the present invention. A continuous web 50 is provided on which a number of magnetic business communication pieces have been placed, 52, 54, 56 and 58. The pieces are shown with a slight overlap represented by 53, 55 and 57. The overlap can be created by the placer mechanism as previously described herein.

It will thus be seen according to the present invention a highly advantageous method and system for producing variably configured magnetic templates has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A method for producing variably configured business communication magnetic templates, comprising the steps of;
obtaining an order for a magnetic business communication piece;
designing a layout for said business communication piece, said layout including at least a printed portion and a piece shape configuration;
preparing a substrate, said substrate having a top printable surface and lower magnetic layer with said top printable surface permanently bonded to said lower magnetic layer;
feeding said substrate to a printing station;
producing imaging on said substrate at said printing station on said top printable surface to produce a printed intermediate;
transferring said printed intermediate to a cutting station; and
cutting said printed intermediate from said substrate in accordance with said piece shape configuration to create at least one variably configured business communication magnetic template.

2. A method as recited in claim 1, wherein said business communication magnetic template is selected from a group including marketing, advertising, information handling pieces and combinations thereof.

3. A method as recited in claim 1, wherein said cutting station is a laser die cutter generating electromagnetic radiation in one of light spectrums including ultraviolet, infrared and visible.

4. A method as recited in claim 1, wherein said piece shape configuration is selected from a group including geometric, animate, inanimate and combinations thereof.

5. A method as recited in claim 1, wherein said order is obtained from a distributor of printed products.

6. A method as recited in claim 1, wherein said layout is prepared by a computer in a digital format.

7. A method as recited in claim 1, wherein said substrate is prepared in a continuous web format.

8. A method as recited in claim 1, wherein said substrate is prepared in a cut sheet format.

9. A method for creating printed magnetic communication pieces for marketing and advertising clients, comprising the steps of;
soliciting production of magnetic communication product orders from one or more clients that have end users customers that utilize marketing and advertising materials;
procuring at least one order from one of said clients, said one order including rendering of textual and graphical depictions on a substrate having a magnetic layer;
creating a layout digitally for use in preparing said substrate, said layout including at least information relating to placement of said textual and graphical depictions and shape configuration information relating to said order;
providing said substrate, said substrate having a top printable layer and a bottom magnetic layer with a portion of said top printable layer permanently bonded to said magnetic layer;
imaging said textual and graphical depictions on said top printable layer of said substrate to create an intermediate substrate having at least one area prepared in connection with said order;
transferring said intermediate substrate to separating station that will separate said at least one area from said substrate;
cutting said at least one area from said substrate by using electromagnetic radiation in a light spectrum selected from visible, infrared or ultraviolet to create a business communication magnetic product;
collecting said business communication magnetic product; and
packaging said business communication magnetic product for delivery.

10. A method as recited in claim 9, wherein the step of imaging is practiced using printing equipment having a resolution of greater than about 150 lines per inch.

11. A method as recited in claim 9, wherein said step of soliciting orders is accomplished through at least one of printed, visual or oral communications directed at resellers of printed products.

12. A method as recited in claim 9, wherein said shape configuration information is non-quadrate.

13. A method as recited in claim 9, including a further step of proofing said layout after the step of creating said layout.

14. A method as recited in claim 9, including a further step of obtaining acceptance of said layout prior to the step of creating said layout.

15. A method as recited in claim 9, wherein said step of packaging includes preparing for shipment of said product to an end user customer of said client.

16. A method as recited in claim 9, including a further step of placing said business communication magnetic product in a discrete area on a continuous substrate after the said step of collecting said product.

17. A method as recited in claim 16, including a further step separating said discrete area from said continuous substrate prior to the step of packaging said business communication magnetic product.

18. A method as recited in claim 16, including a further step of producing multiple business communication magnetic products and placing each of said products sequentially in discrete areas on a continuous web after the step of collecting.

19. A method of producing a series of magnetic business communication templates, comprising the steps of;
preparing a layout for an order for a series of magnetic business communication templates, said layout including a printed design portion and a shape configuration determination;
providing a substrate sized and configured to receive said series of magnetic business communication templates, said substrate having a top printable surface that is bonded to a magnetic lower surface;
printing each of said templates on said substrate on said top printable surface;
cutting each of said templates from said substrate by using electromagnetic radiation in a light spectrum selected from visible, infrared or ultraviolet to create individual printed business communication magnetic products;
placing, sequentially each of said printed business communication magnetic products on a carrier web; and
preparing said printed business communication magnetic products for delivery to a customer.

20. A method as recited in claim 19, wherein each of said printed business communication magnetic products are placed in a slightly overlapping arrangement on said carrier web.
